(19) United States
(12) Patent Application Publication
(10) Pub. No.: US 2003/0007059 A1
(43) Pub. Date: Jan. 9, 2003

(54) Method for controling the heating elements of a thermal print head

(76) Inventors: Roland Aigner, Hallein-Rif (AT); Walter Lechner, Wals (AT)

Correspondence Address: Flynn Thiel Boutell &Tanis, 2026 Rambling Road, Kalamazoo, MI, 49008-1699, US

(21) Appl. No.: 10/030,006

(22) PCT Filed: Mar. 7, 2001
(86) PCT No.: PCT/EP01/02568

(30) Foreign Application Priority Data
Mar. 14, 2000 (DE) 100 12 360.0

(51) Int. Cl. B41J 2/35

(52) U.S. Cl. 347/211

(57) ABSTRACT

For recording and erasure of data on a reversibly writable thermal recording material (5) with a thermal print head (2), the heating elements (8) of the thermal print head for recording are subjected to an energy pulse (W) which causes the recording material to be heated to a temperature (T1) at which it assumes a colored and/or opaque state. For erasure subsequent to the recording pulse (W), the heating elements (8) are subjected to an energy pulse train (E1).

This invention relates to a method for controlling the heating elements of a thermal print head for recording and erasing dots with a reversibly writable thermal recording material.

A reversibly writable thermal recording material is characterized in that its transparency and/or color can change reversibly from a transparent and/or colorless state to an opaque and/or colored state and vice versa in dependence on temperature.

The reversibly writable thermal recording material is supplied step-by-step to the thermal print head having a row of individually drivable resistance heating elements extending over the total printing width transversely to the transport direction of the thermal recording material. In each step one can thus record a line of dots corresponding to the row of heating elements if the heating elements are heated to a temperature leading to the colored/opaque state of the thermal recording material.

Erasure of the colored/opaque dots can be effected by a second thermal print head whose heating elements are heated to a temperature at which the reversibly writable thermal recording material changes back to the colorless/transparent state. One can also use a single thermal print head which erases when the recording material is moved along it in one direction, and records, i.e. writes dots, upon subsequent movement of the recording material in the reverse direction (DE 41 30 539 A1).

DE 42 10 379 C2 discloses first applying an energy pulse train to drive the heating elements that are to record a dot and then applying another energy pulse train to the heating elements that are to perform dot-by-dot erasure, in each transport cycle.

In known reversible recording methods, however, the recording speed leaves something to be desired.

The problem of the invention is to substantially increase the recording and erase speed in thermal printing of a reversibly writable recording material.

This is obtained according to the invention by the method characterized in claim 1. The subclaims render advantageous embodiments of the inventive method.

According to the invention the heating elements are driven for writing with a single energy pulse leading to a temperature at which the reversibly writable thermal recording material assumes a first, high temperature leading to the colored/opaque state.

The heating elements which are to perform erasure are then subjected to an energy pulse train when the maximum temperature has been reached after the recording pulse. This permits the processing, i.e. recording and erasure of the individual dots of a printed line, to be reduced to 3 milliseconds or less and an accordingly high recording and erase speed to be reached.

According to the invention one uses a reversibly writable thermal recording material that becomes colored and/or opaque at the first, high temperature, retains the colored/opaque state upon rapid cooling but loses it upon slow cooling, but whose colored/opaque state is also lost if constant heating to a second lower temperature takes place.

The first high temperature that makes the thermal recording material become colored or opaque, i.e. milky, may be 150° C. or more for example. The second lower temperature to be held constant leading to erasure is preferably at least 20° C. lower.

Therefore, the heating elements can be subjected to the energy pulse train for erasure in two variants according to the invention.

According to one variant, all heating elements are first driven with the recording energy pulse and subsequent to the recording energy pulse an energy pulse train is supplied that slows down the cooling of those heating elements which are to bring about erasure such that the recording material assumes its colorless/transparent state. In this variant, all heating elements are thus in each cycle first heated to the temperature necessary for coloring the recording material and the heating elements that are to erase dot-by-dot are then subjected to the pulse train in order to cool more slowly than the other heating elements. It is obvious that one need not necessarily drive all heating elements of the thermal print head in this fashion, but only those which correspond to the desired printing width. It is also clear that the colorless/transparent state might also have a different color from the one appearing upon coloring of the thermal recording material.

According to the other variant, the heating elements for recording are subjected to the recording energy pulse and the heating elements for erasure, directly subsequent to the recording energy pulse, to an energy pulse train which heats the heating elements to a second temperature to be held constant at which the thermal recording material assumes a transparent/colorless state, the second temperature being below the temperature producing the colored/opaque state.

In the second variant, however, the second temperature must in general be held for a certain time of at least 1 millisecond for erasure. It is therefore in general somewhat slower than the first variant. That is, the pulse duration for the recording pulse is approximately 1 to 2 milliseconds. Whereas the duration of the pulse train supplied during cooling in the first variant is approximately 1 to 2 milliseconds, the duration of the pulse train for erasure in the second variant is approximately 2 to 3 milliseconds in order to hold the temperature for at least approximately 1 millisecond at the second temperature at which the thermal recording material assumes the transparent/colorless state.

The reversibly writable thermal recording material that can be used according to the invention may be any known reversibly writable thermal recording material (compare DE 41 30 539 A1, DE 42 10 379 C2 and 42 00 474 C2). However, one preferably uses a recording material available on the market that consists of a mixture of a leuco dye and a developer. The leuco dye may be a xanthene derivative. Preferably, the xanthene has a dialkylamine residue at the 3 position and at its 9 position a phenyl residue is bound with a carboxyl acid group at the ortho position so that, as in fluorescein, a lactone ring forms with the 9 position in the leuco form, said ring being open in the colored state through reformation of the carboxyl group. As a developer one can use an acid amide of carboxylic acid with a para-aminophenol and/or a urea derivative substituted with a para-hydroxyphenyl residue on an amino group and with an alkyl residue on the other amino group.

The energy supply for erasure in the form of a pulse train obtains fine temperature control according to the invention. For this purpose the pulse train has pulses with the same period of preferably less than 100 microseconds, in particular less as 50 microseconds. The pulse/pause ratio per period is preferably at most 1:1, in particular approximately 1:2. That is, at a period of e.g. 30 microseconds the pulse duration is 10 microseconds and the pause 20 microseconds for example.

Preferably, the heating elements of the thermal print head are preheated before processing, i.e. recording and erasure, to a temperature that is preferably at least 30° C. below the second, i.e. erase, temperature. If the erase temperature is 120° C. for example, the preheating temperature can be approximately 60° C. for example.

Such preheating in thermal printing is indicated for example by DE 30 33 746 A1. Preheating lowers the temperature difference until recording or erasure, i.e. reduces the heating capacity necessary for printing, thereby achieving a higher printing speed due to the faster heating of the resistance heating elements. Moreover, the erase quality is clearly improved.

While according to DE 38 33 746 A1 the clock frequency during preheating should be no more than the quadruple of the pulse duration for recording and the pulse width during preheating should be constant, according to the invention the period of the single pulses of the pulse train for preheating is less than 100 microseconds, in particular less than 50 microseconds, i.e. less than one tenth, preferably less than one twentieth, of the pulse duration at a pulse duration for the recording pulse of 1 to 2 milliseconds.

In order to permit the desired preheating temperature to be adjusted as exactly as possible, the pulse/pause ratio per period is furthermore preferably reduced with increasing temperature of the thermal print head. Thus, at a constant period of the single pulses, the pulse duration can be for example 10% or less of the period at the beginning of preheating, and for example 3% or less at the end of the preheating process or for holding the preheating temperature. That is, at a period of for example 30 microseconds per single pulse, the pulse duration can be for example 2 microseconds at the beginning of preheating and for example 0.5 microseconds at the end of preheating and for holding the preheating temperature.

The pulse duration during preheating can be controlled for example by the temperature of the thermal print head, which can be measured with a temperature sensor, for example a temperature-dependent resistor with a negative temperature coefficient.

Under these circumstances, the preheating temperature of the heating elements can be adjusted to for example ±0.2° C. or even more exactly. The thermal print head is thus minimally stressed thermally and its life essentially increased. As experinents indicate, this even makes the life longer than without preheating since the thermal print head is subject to smaller temperature jumps during recording. The period of the single pulses of the pulse train during preheating preferably corresponds to the period of the single pulses of the pulse train for erasure, being for example 30 microseconds in both cases.

In the following, the invention will be explained in more detail by way of example with reference to the drawings, in which:

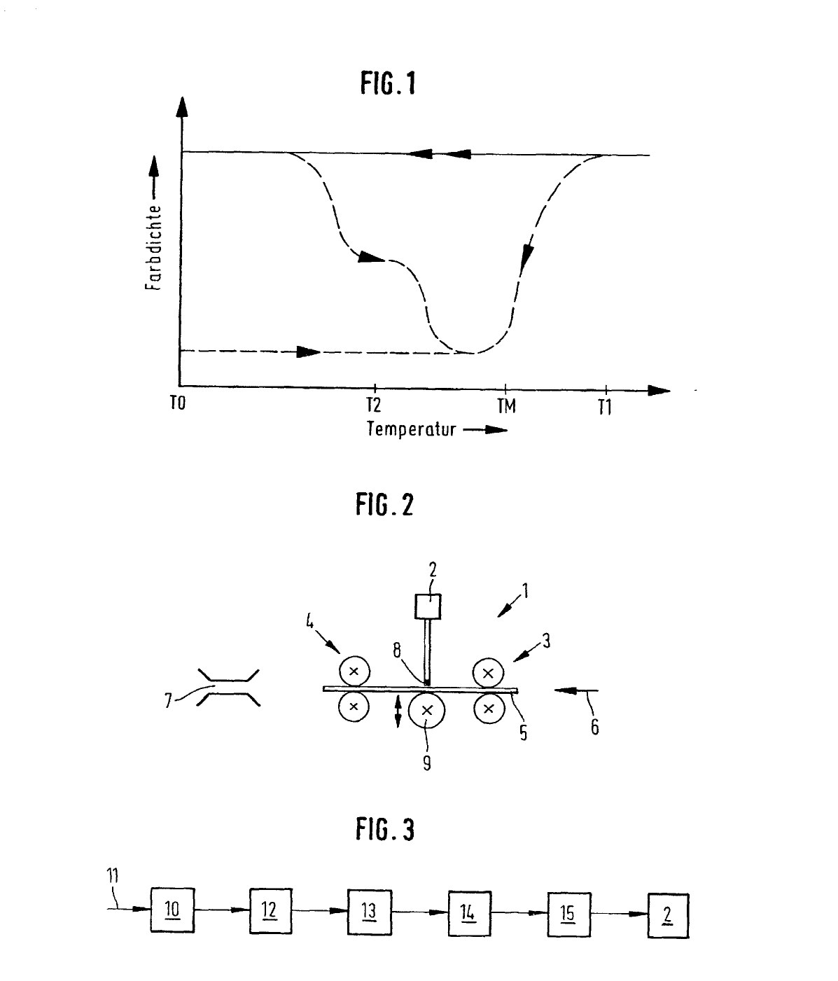

FIG. 1 shows a diagram representing the change in color density of a reversible heat-sensitive recording material for use in the inventive method in dependence on temperature;

FIG. 2 shows schematically a thermal printer for reversible printing of entitlement cards;

FIG. 3 shows a block diagram for driving the thermal print head; and

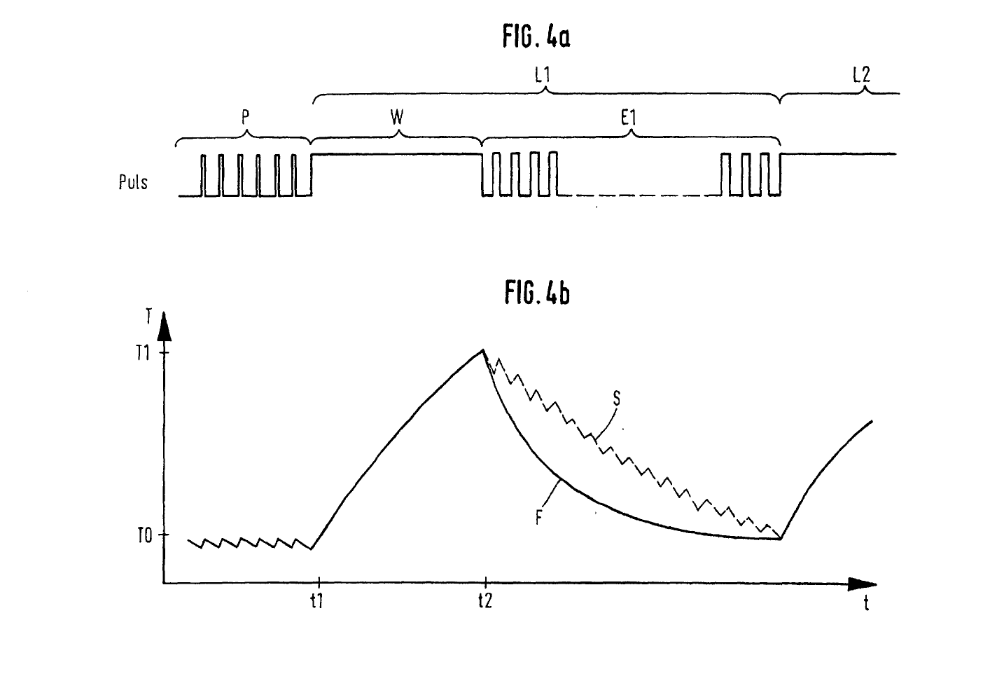

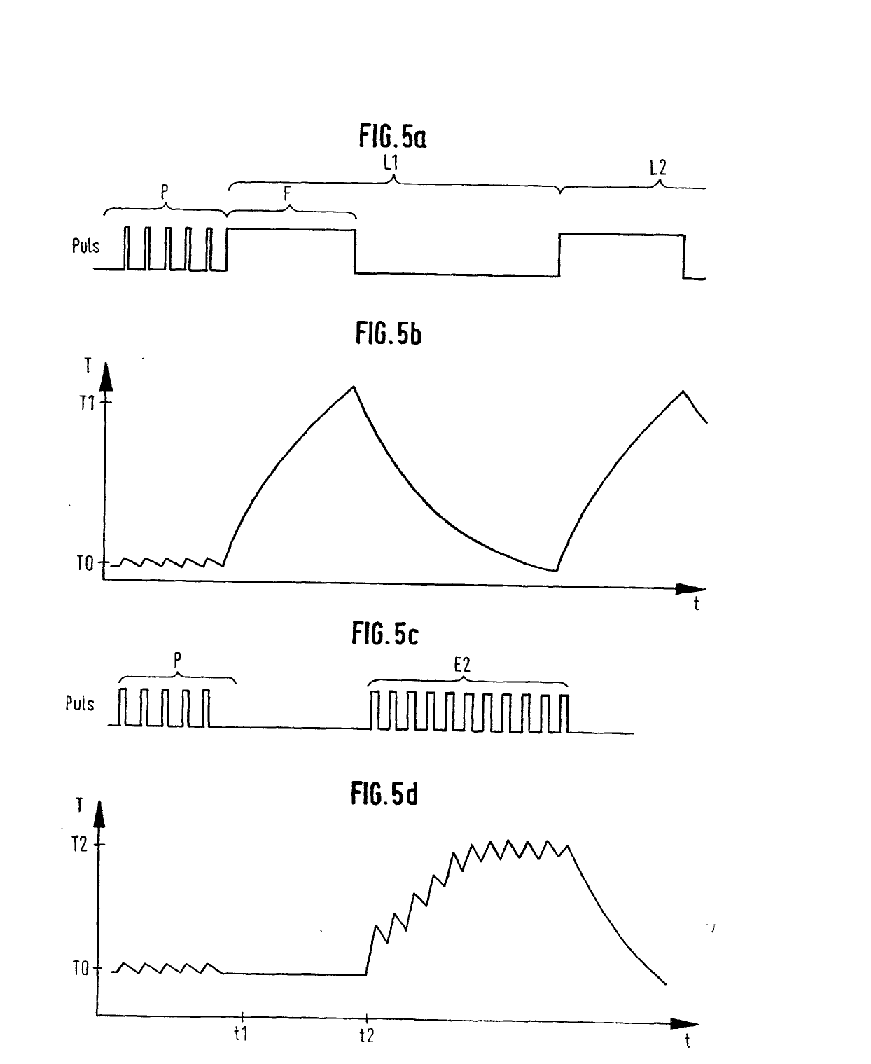

FIGS. 4 and 5 show diagrams for illustrating the first and second variants of the inventive method.

According to FIG. 1, the reversible thermal recording material exists at T0 in a transparent and/or colorless state, i.e. with low color density. T0 may be room temperature or lower, or be a preheating temperature. Heating from T0 to T1 (e.g. 160° C.) causes the color density to increase according to the dashed line, in particular after melting point TM of the reversible thermal dye has been exceeded. While the colored and/or opaque state is retained when rapid cooling takes place from T1 according to the unbroken line, the colorless and/or transparent state is assumed again when the thermal recording material is cooled down slowly from temperature T1 according to the dashed line, or when it is heated constantly to erase temperature T2.

According to FIG. 2, thermal printer 1 has thermal print head 2 between two pairs of feed rollers 3, 4. Entitlement cards 5 are supplied according to arrow 6, moved step-by-step with feed rollers 3, 4 along thermal print head 2 for processing and outputted via output slit 7.

On its edge facing card 5, print head 2 has individually drivable resistance heating elements 8 that form on card 5 a row extending transversely to transport direction 6. Heating elements 8 are driven between two consecutive transport steps and thereby heated. Simultaneously, counterpressure roller 9 is pressed against card 5. Thus, according to the invention all heating elements 8 are first subjected to an energy pulse which causes the recording material to assume a colored/opaque state along the line. Directly thereafter, heating elements 8 are driven with an energy pulse train at the dots of the recording material or card 5 where erasure is to take place.

According to FIG. 3, shift register 10 for example receives data 11 from a data source not shown for the information to be represented on card 5. Discriminator 12 distinguishes whether a colored/opaque dot or a colorless/transparent dot is to be formed on the card by relevant heating element 8 for the information recording in the particular transport step. Processing section 13 defines the data in order to generate the recording energy pulse and erase energy pulse train. The pulse data are decoded by decoder 14 into a total pulse train for driving heating elements 8 for processing the relevant line of card 5 and this total pulse train fed to driver 15.

FIG. 4 shows for the first variant of the inventive method in (a) the pulse train for driving heating elements 8 and in (b) the temperature of the thermal recording material upon reception of the pulse train.

Thus, all heating elements 8 are driven for preheating or for holding temperature T0 of for example 60° C. with pulse train P having a period of e.g. 30 microseconds and a pulse duration per period of e.g. 2 to 0.3 microseconds, depending on how great the difference is between the temperature measured by the temperature sensor (not shown) and given preheating temperature T0.

For processing a line, all heating elements 8 are subjected at t1 to recording pulse W of e.g. 1 to 2 milliseconds, causing the temperature of thermal recording material to rise at the end of the recording pulse at t2 to temperature T1 of e.g. 160° C., i.e. a temperature above the temperature at which the reversible heat-sensitive recording material assumes a colored and/or opaque state.

Heating elements 8 at the dots of the line which are to be erased are driven directly after pulse W with pulse train E1. It consists for example of single pulses with a period of 30 microseconds, whereby the pulse duration may be e.g. 10 microseconds and the pause duration for example 20 microseconds per period.

While the temperature of relevant heating element 8 decreases from T1 exponentially, i.e. rapidly, according to curve F without pulse train E1, a more linear, slower cooling takes place to preheating or starting temperature T0 according to dashed sawtooth curve S under the action,of pulse train E1.

In FIG. 4, L1 represents the time period for processing, i.e. printing and erasing, the first line, and L2 for processing the second line.

While according to the diagram of FIG. 1 the colored/opaque state is retained through the rapid cooling according to curve F, erasure of the particular colored/opaque dot takes place through the slower, more uniform cooling according to curve S.

The embodiment according to FIG. 5 differs from that according to FIG. 4 substantially in that directly after pulse F heating elements 8 are subjected, at the dots of the line where erasure is to be effected, to pulse train E2 which raises the temperature of relevant heating element 8 according to curve C to temperature T2 which is below temperature T1 according to the diagram of FIG. 1. In FIG. 5, (a) represents the pulse train supplied to the heating elements for recording, and (c) the pulse train which drives the heating elements for erasure, while (b) and (d) represent the temperature/time diagram upon reception of pulse trains (a) and (c).

1. A method for controlling the heating elements of a thermal print head for recording and erasing data on a reversibly writable thermal recording material, characterized in that the heating elements for recording are subjected to an energy pulse which causes the recording material to be heated to a temperature (T1) at which it assumes a colored or opaque state, and the heating elements for erasure are subjected to an energy pulse train subsequent to the recording pulse.

2. A method according to claim 1, characterized in that the heating elements for erasure are subjected, subsequent to the recording pulse, to a pulse train which delays the cooling of the heating elements such that the recording material assumes a colorless or transparent state.

3. A method according to claim 1, characterized in that the heating elements for erasure are subjected, subsequent to the recording pulse, to a pulse train which heats them to a second temperature (T2) at which the thermal recording material assumes a colorless or transparent state, the second temperature (T2) being below the first temperature (T1) at which the thermal recording material assumes the colored or opaque state.

4. A method according to claim 3, characterized in that the pulse train brings about the second temperature (T2) for at least 1 millisecond.

5. A method according to any of the above claims, characterized in that the heating elements are preheated for recording and erasure to a predetermined temperature (T0) by an energy pulse train.

6. A method according to any of the above claims, characterized in that the pulse train for erasure and/or for preheating consists of pulses with the same period.

7. A method according to claim 6, characterized in that the period of the single pulses of the pulse train is at most 100 microseconds.

8. A method according to claim 6, characterized in that the pulse/pause ratio of the pulse train for erasure per period is at most 1:1.

9. A method according to claim 6, characterized in that the pulse/pause ratio of the pulse train for preheating per period is reduced with increasing temperature of the thermal print head.
